(19) United States
(12) Patent Application Publication
(10) Pub. No.: US 2008/0295249 A1
(43) Pub. Date: Dec. 4, 2008

(54) Patient Transport System

(76) Inventors: Mark Andrew Noltimier, Columbus, OH (US); Henry C. Berns, JR., Westerville, OH (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/754,693

(22) Filed: May 29, 2007

(51) Int. Cl. A61G 99/00

(52) U.S. Cl. 5/620

(57) ABSTRACT

The disclosure provides a device for converting a passenger vehicle to a patient transport vehicle including a bracket configured to mount to a seat located in a passenger vehicle, a wear strip attached to the bracket, the wear strip comprising a flat surface configured to support a stretcher, and a tie down system configured to releasably attach a stretcher to the bracket when the stretcher is in contact with the wear strip.

### TECHNICAL FIELD OF THE DISCLOSURE

The present disclosure relates to devices, systems, and methods for transporting patients, including devices, systems and methods for converting a passenger bus into a stretcher transport vehicle.

### BACKGROUND OF THE DISCLOSURE

During times of war and/or natural disasters, soldiers and/or teams of workers/volunteers may be sent in affected areas to treat, collect and/or transport large numbers of casualties. These casualties may include persons in need of sophisticated medical attention or treatment. In order to provide such treatment, the casualties often must be transported a substantial geographic distance from the war/disaster. For example, patients may be transported to another location where electrical power, advanced treatment facilities and/or specialty trained medical staff are located. In another example, remaining in the affected area may expose patients and those teams attempting to provide services to further danger of injury, e.g., continued warfare, flooding, rioting, and/or exposure to other dangerous conditions.

Emergency transport vehicles may include road-going patient transport ambulances, helicopters, or other emergency ambulances. In some instances of mass casualty, there may not be sufficient numbers of emergency transport vehicles on hand to safely transport the number of casualties present. For example, emergency transport vehicles may be located at a substantial distance from the patients to be transported. In another example, emergency transport vehicles may be unable to travel between their location and the location of the casualties, e.g., roads are damaged and/or impassable. In such cases, standard passenger vehicles may be used to transport patients.

### SUMMARY OF THE DISCLOSURE

Devices, systems and methods useful in converting available passenger vehicles into appropriate vehicles for transporting mass casualties or patients are sought by users and organizations responsible for mobilizing a response to large catastrophes and other accidents. Some examples of such systems include permanent modification and/or dedication of such passenger vehicles into patient transport vehicles. In accordance with the present disclosure, one example of such a system may be useful to convert a school bus or other passenger vehicle into a stretcher transport vehicle without substantial or permanent modification.

In accordance with one embodiment of the present disclosure, a device for converting a passenger vehicle to a patient transport vehicle may include a bracket, a wear strip attached to the bracket, and a tie down system configured to releasably attach a stretcher to the bracket when the stretcher is in contact with the wear strip. The bracket may be configured to mount to a seat located in the passenger vehicle. The wear strip may comprise a flat surface configured to support a stretcher.

In accordance with one embodiment of the present disclosure, a system for converting a passenger vehicle to a patient transport vehicle may include three brackets. Each bracket may include a wear strip and a tie down system. The three brackets may be configured to mount to seats located in a passenger vehicle. The wear strip may include a flat surface configured to support a stretcher. The tie down system may be configured to releasably attach a stretcher to the bracket.

In accordance with one embodiment of the present disclosure, a method for converting a passenger vehicle into a patient transport vehicle may include placing a bracket on an upright portion of a passenger seat, loading a stretcher onto the bracket, and fastening the stretcher to the bracket by operation of a tie down system.

### BRIEF DESCRIPTION OF THE DRAWINGS

Some embodiments of the disclosure may be understood by referring, in part, to the following description and the accompanying drawings, wherein:

FIG. 1 shows several conversion devices in place on the back of bus seats that may be used in accordance with teachings of the present disclosure;

FIG. 2A shows a conversion device that may be used in accordance with teachings of the present disclosure;

FIG. 2B shows another embodiment of a conversion device that may be used in accordance with teachings of the present disclosure;

FIG. 3 shows two stretchers in place atop several brackets attached to the back of bus seats that may be used in accordance with teachings of the present disclosure;

FIG. 4 shows an isometric view of the passenger section of a school bus in which one embodiment of the present disclosure has been deployed in accordance with teachings of the present disclosure;

FIG. 5 shows a plan view of the deployment depicted in FIG. 4; and

FIG. 6 shows one package that may be used to contain a system for use in accordance with teachings of the present disclosure.

### DETAILED DESCRIPTION OF THE DRAWINGS

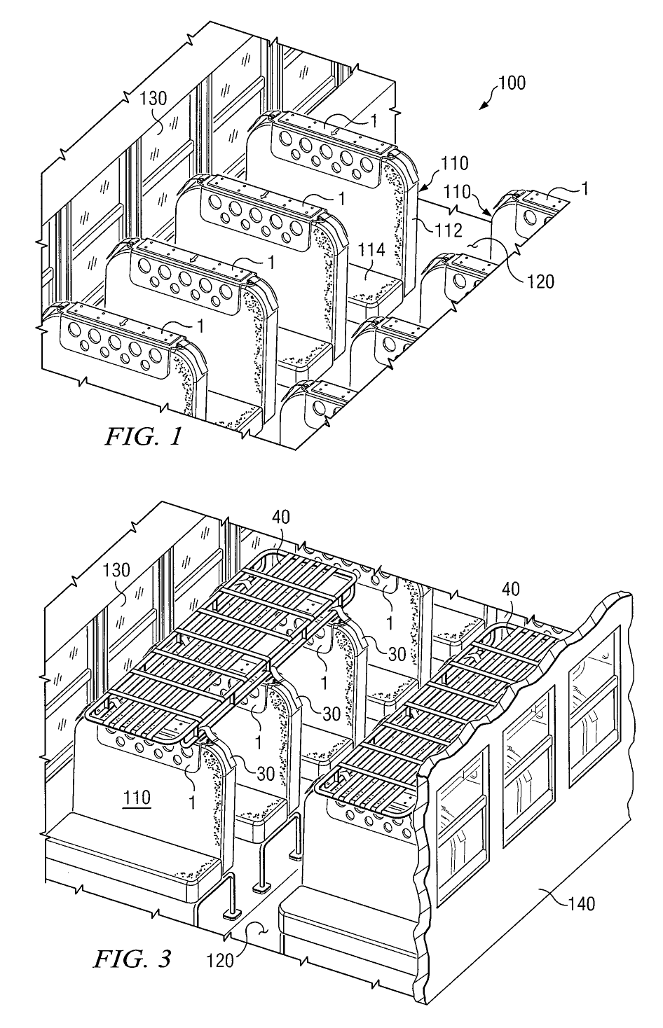

Selected embodiments of the disclosure may be understood by reference, in part, to FIGS. 1-6, wherein like numbers refer to same and like parts. The present disclosure is broadly concerned with devices and systems adapted to be deployed in association with conventional passenger vehicles (e.g., passenger buses, vans, and/or trains) to convert such vehicles into patient transport vehicles (e.g., transports for multiple stretchers and/or patients. In some embodiments, the device or system may include a set of brackets configured to mount to a seat or any other feature or component of a passenger vehicle. The brackets may include features or components configured to mate with the seat. The bracket may also include features or components configured to mate with patient stretchers, backboards, and/or any other device useful for transporting a patient. When a set of brackets is deployed within a passenger vehicle, that passenger vehicle may be converted into an appropriate platform for transporting one or more patients.

FIG. 1 is an illustration of one portion of a school bus 100 in which a conversion device 1 has been deployed in accordance with teachings of the present disclosure. Conversion device 1 may include any features configured to provide an appropriate platform for transporting patients. As shown in FIG. 1, school bus 100 may include one or more seats 110, a floor 120, and one or more windows 130. Seats 110 may include any feature or component typically used for passenger seating (e.g., a seat back 112 and a bench 114). As shown in FIG. 1, conversion device 1 may include any features or components configured to attach to seats 110. In other embodiments, conversion device 1 may be configured to attach to other fixtures or features of school bus 100 and/or any other passenger vehicle. In embodiments such as the one shown in FIG. 1, conversion device 1 may be installed without tools and may be used with a wide variety of patient transport options (e.g., a stretcher, a backboard, and/or any other patient transport device). In addition, conversion device 1 shown in FIG. 1 may be installed without substantial training.

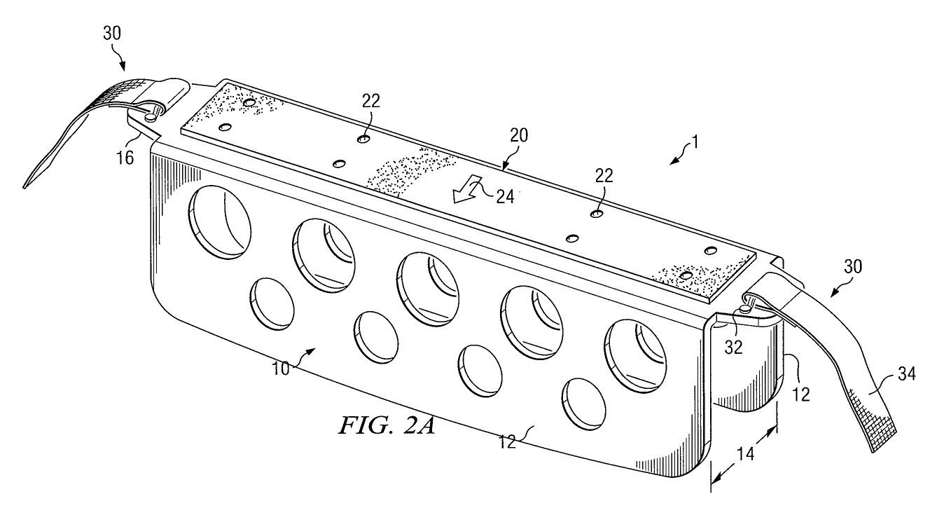

FIG. 2A is an illustration of one embodiment of conversion device 1 that may be used in accordance with teachings of the present disclosure. Conversion device 1 may include any device or feature configured to provide a stable fixture to allow a patient to be safely transported in a passenger vehicle (e.g., a school bus). For example, some embodiments of conversion device 1 may include a bracket 10 configured to mount to a seat, a wear strip 20 attached to bracket 10 and configured to provide a support surface for a stretcher, and a tie down system 30 configured to releasably attach the stretcher to bracket 10.

Bracket 10 may include any device or features configured to clasp, connect and/or mate with a seat located in a passenger vehicle. For example, bracket 10 may comprise a clip, a clamp, a rigid frame, and/or any other suitable component for mating with seat back 112. In some embodiments, bracket 10 may be configured to mate with one or more specific features of a passenger vehicle (e.g., a seat back, a door handle, a head rest, and/or any other known device and/or component of a passenger vehicle). In other embodiments, bracket 10 may include adjustable features or devices configured to allow bracket 10 to mate to a variety of devices or components of a passenger vehicle.

For example, bracket 10 may include a rigid u-shaped channel including two arms 12 and a gap 14. In embodiments such as that shown in FIG. 2, bracket 10 may be configured to mount to the upright portion of a seat. For example, bracket 10 may be configured to mount on seat back 112 of school bus 100. In other embodiments, bracket 10 may be configured to mount on bench 114 or the seat of a different passenger vehicle.

Arms 12 may include any feature or component of bracket 10 extending from bracket 10. Arms 12 may be configured to rest on opposing sides of a component of a passenger vehicle. For example, arms 12 may be extended flat portions of bracket 10 configured to rest on the front and back of the upright portion of a seat (e.g., seat back 112). Arms 12 may be rigid extensions (e.g., those shown in FIG. 2).

In other embodiments, bracket 10 may include two or more arms 12 comprising opposing sides of a clamp or clip. For example, arms 12 may be flexible extensions or spring-loaded rigid arms. In such embodiments, bracket 10 may be installed or mounted to a passenger vehicle by extending arms 12 and clamping onto a seat. Such clamps may be configured to provide compressive force to seat back 112 when installed.

Gap 14 may be a fixed distance between arms 12. In embodiments configured to mate with a specific seat back 112, gap 14 may be selected to provide compressive force to seat back 112 once installed. In other embodiments, gap 14 may be an adjustable distance between arms 12 allowing use on a range of seat backs 112 or other features or components present in a passenger vehicle.

Bracket 10 may also include a friction strip 16 or other grip pad. Friction strip 16 may be any feature of bracket 10, component, and/or device used to increase the friction between bracket 10 and a passenger vehicle (e.g., seat back 112 of school bus 100). Friction strip 16 may be formed from any material with a high coefficient of friction. Friction strip 16 may provide increased resistance to lateral movement by bracket 10. Embodiments including friction strip 16 may increase the load safely transported or make a patient or other passenger more comfortable by reducing and/or eliminating motion. In some embodiments, friction strip 16 may include a textured portion of bracket 10. For example, for some uses, it is estimated that the lateral force capacity of bracket 10 when in use should be at least around six or seven times the weight of a patient to be transported. In some embodiments, the lateral forces resulting from the transportation of a patient and/or his/her stretcher may be spread across more than one bracket 10. In such cases, the sum of the lateral force capacity for all engaged brackets may be used.

Wear strip 20 may be formed from any material appropriate for use as a mounting surface for a stretcher. Wear strip 20 may be chosen to provide a reduced friction surface allowing a stretcher to slide across wear strip 20 when loaded with a patient. For example, wear strip 20 may be formed out of a low friction material (e.g., a thermoplastic e.g., nylon, HDPE and/or PTFE).

In some embodiments, wear strip 20 may be mechanically fastened to bracket 10 with one or more connectors 22. Connectors 22 may be any device or components used to connect wear strip 20 to bracket 10 (e.g., rivets, bolts, clips and/or other fasteners). In other embodiments, wear strip 20 may be connected to bracket 10 by an adhesive or other material without connectors. In still other embodiments, wear strip 20 may be integral with bracket 10 or formed in a single fabrication step. For example, wear strip 20 may be friction fit into a groove on bracket 10 or otherwise connected without connectors 22.

In some embodiments, wear strip 20 may include one or more marks 24. For example, mark 24 may include an arrow (e.g., that shown in FIG. 2) indicating the proper orientation of bracket 10 and/or any useful information in the installation and/or use of conversion device 1. In other embodiments, marks 24 may include instructions or directions comprising text and/or illustrations.

Tie down system 30 may include any features, components, and/or devices used to connect a stretcher to bracket 10. For example, tie down system 30 may include one or more loops 32 and one or more straps 34 used to tie a stretcher against wear strip 20. In some embodiments (e.g., that shown in FIG. 2), tie down system 30 may be attached to bracket 10 so that tie down system 30 is in place for use when bracket 10 is in place.

Loops 32 may include any feature of bracket 10 or additional component used to connect straps 34 to bracket 10. For example, loops 32 may include one or more rings and/or any other device allowing straps 34 to pass through and form a releasable connection (e.g., D-rings, round loops, and/or triangular rings). In other embodiments, loops 32 may be a feature of bracket 10 (e.g., slots and/or holes in bracket 10).

Straps 34 may include any component or device used to hold stretcher firmly against bracket 10 and/or wear strip 20. For example, straps 34 may include two-sided fabric hook and loop fasteners (e.g., VELCRO®). In other examples, straps 34 may include flexible fabric used to pass through loops 32 and/or connect with other features (e.g., snap-hooks, ratchets, clips, and/or clasps).

FIG. 2B shows an illustration of another embodiment of conversion device 1 that may be used in accord with teachings of the present disclosure. Conversion device 1 may include additional features, devices, and/or systems configured to interface with seat 110, some other feature and/or device in school bus 100, and/or increase the strength of the connection between conversion device 1 and school bus 100. For example, as shown in FIG. 2B, conversion device 1 may include slot 25 and strap 26. In such embodiments, strap 26 may be any device and/or feature of conversion device 1 configured to wrap around seat 110 and restrain conversion device 1. For example, strap 26 may include a flexible fabric and/or components used to hold conversion device 1 firmly against seat 110 (e.g., strap 26 may include two-sided fabric hook and loop fasteners (e.g., VELCRO®)). In embodiments including straps 26, conversion device 1 may include slot 25 and/or any feature or device configured to provide an interface between conversion device 1 and strap 26. For example, as shown in FIG. 2B, slot 25 may include a rectangular slot allowing strap 26 to pass therethrough and extend downward to attach to seat 110 and/or any other appropriate device or feature of school bus 100.

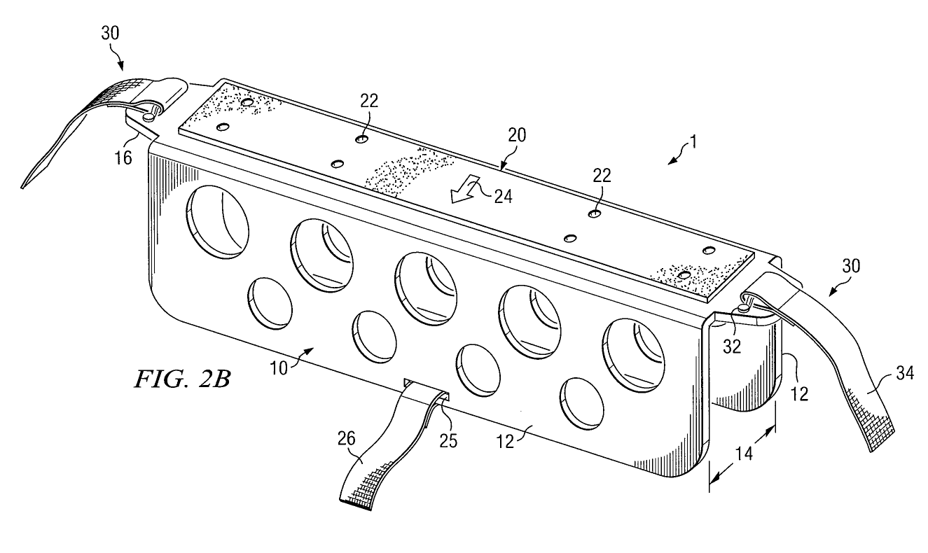

FIG. 3 shows a portion of school bus 100 with several conversion devices 1 installed on seats 110 and two stretchers 40 fastened to conversion devices 1. As shown in FIG. 3, each stretcher may be connected to more than one conversion device 1 (e.g., three conversion devices 1). The number of conversion devices 1 used to tie down or connect each stretcher may depend on the portion of the passenger vehicle used to mount conversion device 1. For example, in embodiments to be used in school buses, the spacing between seats 110 may allow two or more conversion devices 1 to hold each stretcher to seats 110. In the example shown in FIG. 3, conversion devices 1 allow movement of personnel or rescue teams along the bus floor 120. Available space may be constrained by the configuration of seats 110, floor 120, windows 130, and/or the bus walls 140.

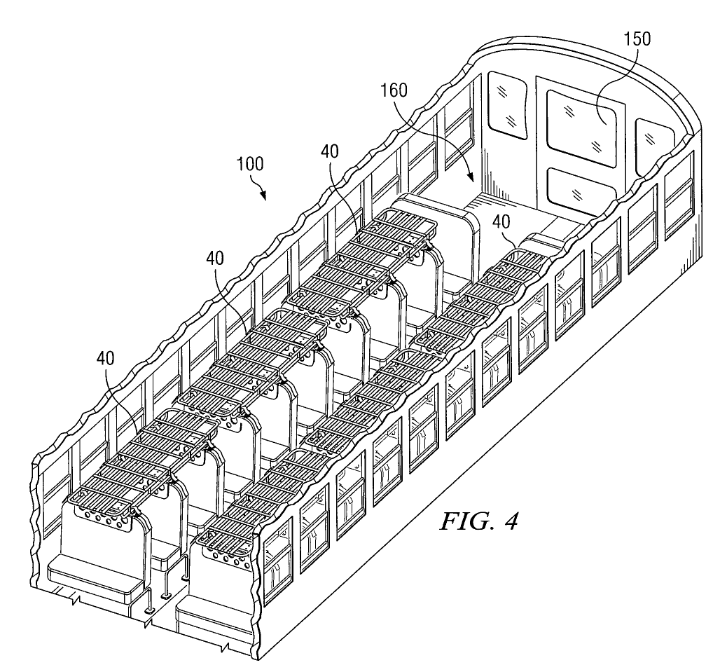

FIG. 4 shows the entire passenger portion of school bus 100 carrying six stretchers 40. Each stretcher 40 shown in FIG. 4 may be attached to three seats 110 by three conversion devices 1. School bus 100 may include a rear door 150 and a workspace 160. Rear door 150 may be used to bring stretchers 40 or patients onto or out of school bus 100. Workspace 160 may be present in a standard school bus 100 or may be created by the removal of one or more seats from school bus 100.

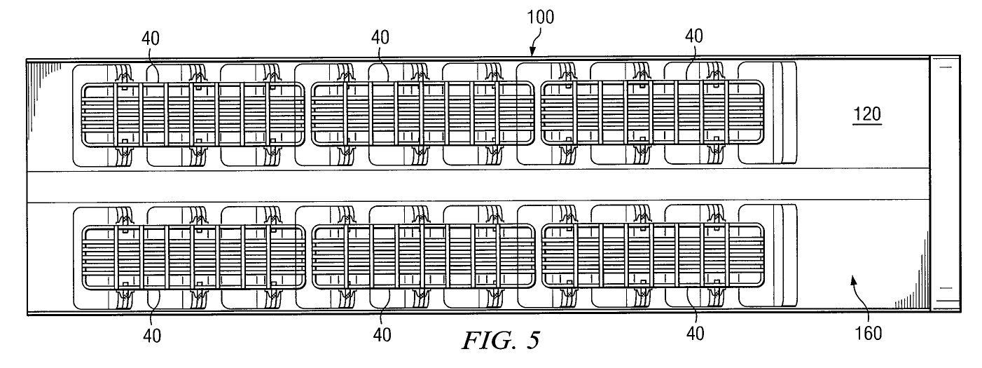

FIG. 5 shows a top view of the passenger portion of school bus 100 as shown in FIG. 4. Workspace 160 may be created by the removal of two seats 110 from school bus 100.

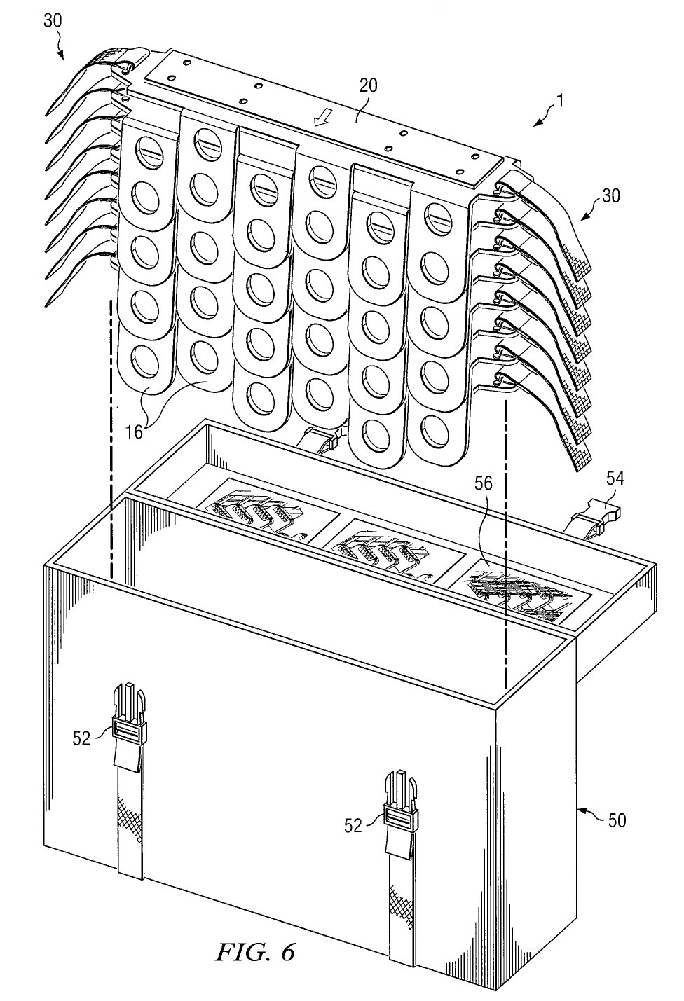

FIG. 6 shows a conversion kit 50 used in accordance with the systems and methods of this disclosure. Conversion kit 50 may include any components, features or devices used to store one or more conversion devices 1. In some embodiments, conversion kit 50 may include a storage unit (e.g., a box, a bag, a satchel, and/or any other storage device). For example, as shown in FIG. 6, conversion kit 50 may include a semi-rigid box configured to store several conversion devices 1. In such embodiments, conversion kit 50 may include one or more clips 52 and 54, and an instruction panel 56.

Clips 52 and 54 may be any device or feature of conversion kit 50 configured to allow a user to close and/or open conversion kit 50. Clips 52 and 54 may be configured to stay closed when conversion kit 50 is lifted but open with minimal effort by a user. For example, clips 52 and 54 may include a zipper, a snap clip, a carabineer, and/or any other clip operable by a user.

Instruction panel 56 may be any portion of conversion kit 50 or separate insert used to convey information to a user. For example, as shown in FIG. 6, instruction panel 56 may include text and pictures illustrating the installation and/or use of conversion devices 1. In other embodiments, instruction panel 56 may be a sheet of paper or other material stored near conversion devices 1.

Conversion devices 1 shown in FIG. 6 illustrate one embodiment of bracket 10 including arms 12 including one or more fingers 16. While bracket 10 may include arms 12 comprising a single extended sheet of material (e.g., as shown in FIGS. 1-4), arms 12 may include any features configured to reduce the package size of conversion kit 50 (e.g., the fingers 16 shown in FIG. 6). In this example, fingers 16 may allow conversion devices 1 to be stacked in a tighter package than the arms 12 shown in FIGS. 1-4.

Conversion devices 1 shown in FIG. 6 may be of any appropriate dimensions, but in at least one embodiment, the conversion device 1 of FIG. 6 may have outside physical dimensions of 6-⅞″×8″×29″ and a weight of around six pounds. A conversion device 1 with those outside physical dimensions may result in a stack in sets of nine conversion devices 1 with total outside physical dimensions of 6-⅞″×15″×29″ and a total weight of around 54 pounds. Such a stack of conversion devices 1 may fit in a conversion kit 50 with total outside dimensions of 8″×16″×30-¼ and a total weight, when nine conversion devices 1 are present inside conversion kit 50, of around 57 pounds. In such embodiments, a school bus 100 may be fully equipped to carry six patients and their stretchers with two conversion kits 50, each conversion kit 50 including nine conversion devices 1, with a total weight of around 114 pounds.

Although the forgoing disclosure is described in relation to the seats of a school bus, it will be appreciated that teachings of the present disclosure may be used satisfactorily with other features of a bus or with other vehicles entirely (e.g., passenger vans, custom buses, boats, and/or any other passenger vehicle). In addition, the teachings of the present disclosure may be used to design or use conversion devices to attach temporary structures to any existing framework. In such cases, the articulation of bracket 10 and tie down system 30 may allow a wide variety of applications.

These equivalents and alternatives along with obvious changes and modifications are intended to be included within the scope of the present disclosure. Accordingly, the foregoing disclosure is intended to be illustrative, but not limiting, of the scope of the disclosure as illustrated by the following claims.

What is claimed is:

1. A device for converting a passenger vehicle to a patient transport vehicle comprising:
a bracket configured to mount to a seat located in a passenger vehicle;
a wear strip attached to the bracket, the wear strip comprising a flat surface configured to support a stretcher; and
a tie down system configured to releasably attach a stretcher to the bracket when the stretcher is in contact with the wear strip.

2. The device of claim 1, wherein the bracket comprises:
two sides; and
a spring configured to pull the two sides together.

3. The device of claim 1, further comprising the bracket configured to grip an upright portion of the seat and prevent the bracket from moving relative to the seat.

4. The device of claim 1, wherein the bracket includes fingers configured to grip an upright portion of the seat.

5. The device of claim 1, wherein the bracket is configured to compress the seat with enough force to prevent movement but not enough force to damage the materials making up the seat.

6. The device of claim 1, wherein the wear strip comprises material allowing the stretcher to slide across the wear strip.

7. The device of claim 1, wherein the tie down system comprises:
at least two loops mechanically fastened to the bracket; and
a strap hooked to each loop, wherein each strap is configured to releasably secure the stretcher to the bracket.

8. The device of claim 7, wherein the strap comprises a two-sided hook-and-loop fastener.

9. The device of claim 1, further comprising a friction pad attached to the bracket in order to provide increased friction between the bracket and the seat.

10. A system for converting a passenger vehicle to a patient transport vehicle comprising:
three brackets configured to mount to seats located in a passenger vehicle, each bracket comprising:
a wear strip comprising a flat surface configured to support a stretcher; and
a tie down system configured to releasably attach a stretcher to the bracket.

11. The system of claim 10, wherein each bracket further comprises two sides, the bracket configured to act as a spring to pull the two sides together.

12. The system of claim 10, further comprising each bracket configured to grip the seats and prevent each bracket from moving relative to the respective seats.

13. The system of claim 10, wherein each bracket includes fingers configured to grip the seats.

14. The system of claim 10, wherein each bracket is configured to compress the seats with enough force to prevent movement of the brackets relative to the seat but not enough force to damage the materials making up the seat.

15. The system of claim 10, wherein the wear strip comprises material allowing a stretcher to slide across the wear strip.

16. The system of claim 10, wherein the tie down system comprises:
at least two loops mechanically fastened to the bracket; and
a strap hooked to each loop, wherein each strap is configured to releasably secure the stretcher to the bracket.

17. The system of claim 16, wherein the strap comprises a two-sided hook-and-loop fastener.

18. The system of claim 10, further comprising a friction pad attached to the bracket in order to provide increased resistance to movement between the clip and the seat.

19. A method for converting a passenger vehicle into a patient transport vehicle, the method comprising:
placing a bracket on an upright portion of a passenger seat;
loading a stretcher onto the bracket; and
fastening the stretcher to the bracket by operation of a tie down system.

20. The method of claim 19 further comprising placing at least three brackets on the upright portions of at least three seats.

21. The method of claim 19 wherein placing a bracket includes compressing the structure of the passenger seat.

22. The method of claim 19 wherein placing a bracket includes engaging a friction strip between the bracket and the upright portion of the passenger seat.

23. The method of claim 19 wherein loading a stretcher includes sliding the stretcher across a wear strip associated with the bracket.

24. The method of claim 19 wherein fastening the stretcher to the bracket includes engaging two sides of a hook-and-loop fastener.
